(19) United States
(12) Patent Application Publication
(10) Pub. No.: US 2013/0151402 A1
(43) Pub. Date: Jun. 13, 2013

(54) SYSTEMS AND METHODS FOR ELECTRONIC PAYMENT USING A MOBILE DEVICE FOR BILLING TO A SUBSCRIBER ACCOUNT

(71) Applicant: Lee Howard, Fairfax, VA (US)

(72) Inventor: Lee Howard, Fairfax, VA (US)

(73) Assignee: Time Warner Cable Inc., New York, NY (US)

(21) Appl. No.: 13/315,356

(22) Filed: Dec. 9, 2011

(51) Int. Cl. G06Q 20/32; G06Q 20/40

(52) U.S. Cl. 705/40

(57) ABSTRACT

Systems and methods for electronic payment using a mobile device for billing to a subscriber account. A purchaser (also referred to herein as a “subscriber”) who has an account with a service provider for services unrelated to the purchase, engages a merchant in a transaction using a purchaser mobile device. The purchaser mobile device acquires purchase information to complete a purchase and unique purchaser identification information and communicates this information to a merchant mobile device. The merchant mobile device communicates the purchase information and the purchaser information along with unique merchant identification information to a service provider server. The service provider server interacts with the purchaser mobile device to authorize the purchase and bills a subscriber account associated with the purchaser mobile device upon a confirmation of the purchase.

### BACKGROUND

Credit cards have become the instrument of choice for purchasing goods and services, whether from brick and mortar establishments or online stores.

A credit card transaction involves a number of parties. A cardholder is issued a credit card by a financial institution or other organization. The card issuer bills the consumer for repayment and bears the risk that the card is used fraudulently. A merchant is an entity that accepts credit card payments for products or services sold to the cardholder. The merchant has a relationship with an acquiring bank. This relationship may be through an independent sales organization or reseller. A merchant has an account with a bank, which may be the acquiring bank or the reseller. A credit card association sets transaction terms for merchants, card-issuing banks, and acquiring banks.

Some institutions lend their names to an issuer to attract customers that have a strong relationship with that institution, and get paid a fee or a percentage of the balance for each card issued using their name. Examples of typical affinity partners are sports teams, universities, charities, professional organizations, and major retailers.

FIG. 1 is a block diagram illustrating a credit card transaction as is known in the art. As illustrated in FIG. 1, when a credit card is physically presented to a merchant (Circle 1), the card is typically swiped through a point of sale (POS) terminal. A magnetic stripe on the back of the credit card is read by the terminal, and the information is sent to an acquirer (Circle 2). For card not present transactions where the card is not shown (e.g., e-commerce, mail order, and telephone sales), merchants will typically verify that the customer is in physical possession of the card and is the authorized user by asking for additional information such as the security code printed on the back of the card, date of expiry, and billing address.

The acquirer uses the information to request authorization from the card issuer (Circle 3). The card issuer determines whether or not to authorize the transaction and, if authorized, reserves that amount of the cardholder's credit limit for the merchant. An authorization will generate an approval code, which is sent to the acquirer (Circle 4). The acquirer authorizes the transaction (Circle 5) and provides the authorization code to the merchant. The merchant stores the authorization code with transaction data and provides the product to the cardholder (Circle 6).

Authorized transactions are stored by a merchant in “batches”, which are sent to the acquirer. Batches are typically submitted once per day at the end of the business day.

The acquirer sends the batch transactions through the credit card association, which debits the issuers for payment and credits the acquirer. Essentially, the issuer pays the acquirer for the transaction. Once the acquirer has been paid, the acquirer pays the merchant. The merchant receives the amount totaling the funds in the batch minus either the “discount rate,” “mid-qualified rate”, or “non-qualified rate” which are tiers of fees the merchant pays the acquirer for processing the transactions.

The credit card transaction system is operated by financial institutions. While it provides services to merchants and consumers, the system also furthers the business interests of the financial institutions involved.

With the development of new technologies, in particular, portable wireless devices with sophisticated processing capabilities, alternative payment systems that do not require the complex institutional relationships of the current credit card system, are possible.

### SUMMARY

Embodiments are directed to facilitating a transaction between a merchant and a purchaser (also referred to herein as a “subscriber”) who has an account with a provider of unrelated services (i.e., cable company, utility company etc.). The purchases are billed to the subscriber's service provider account rather than through the typical credit card process noted above. The service provider pays the merchant the amount due from the purchaser less a transaction fee. The service provider identifies the purchases as line items on the subscriber's bill that is sent by the service provider. The subscriber pays the service provider for services provided by the service provider and for purchases made during the billing cycle of the service provider.

In an embodiment, the transaction between a merchant and a purchaser are consummated using one or more wireless devices, with verification by the service provider, without presenting a physical credit card.

### DESCRIPTION OF THE DRAWINGS

FIG. 1 is a block diagram illustrating a credit card transaction as is known in the art.

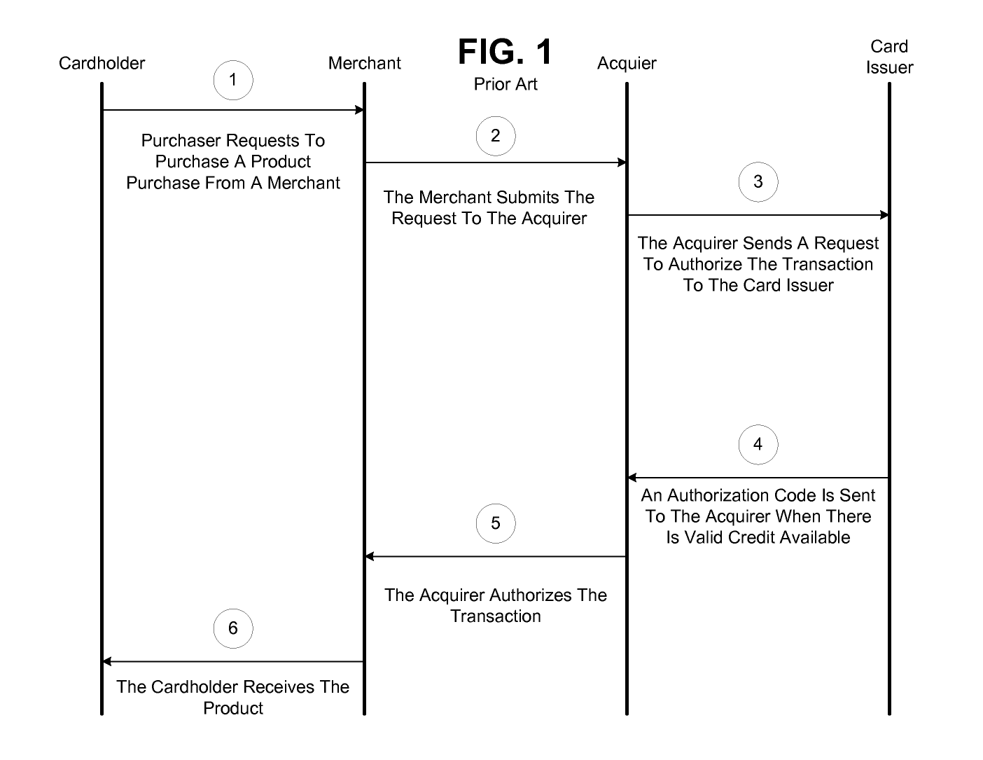

FIG. 2A is a block diagram illustrating a general flow of a transaction according to an embodiment.

FIG. 2B is a block diagram illustrating elements of a purchaser mobile device and a merchant mobile device useful in conducting a transaction according to an embodiment.

FIG. 3 is a block diagram illustrating a mobile device.

FIG. 4 is a block diagram illustrating a computing device.

FIG. 5 is a block diagram illustrating a server device.

### DETAILED DESCRIPTION

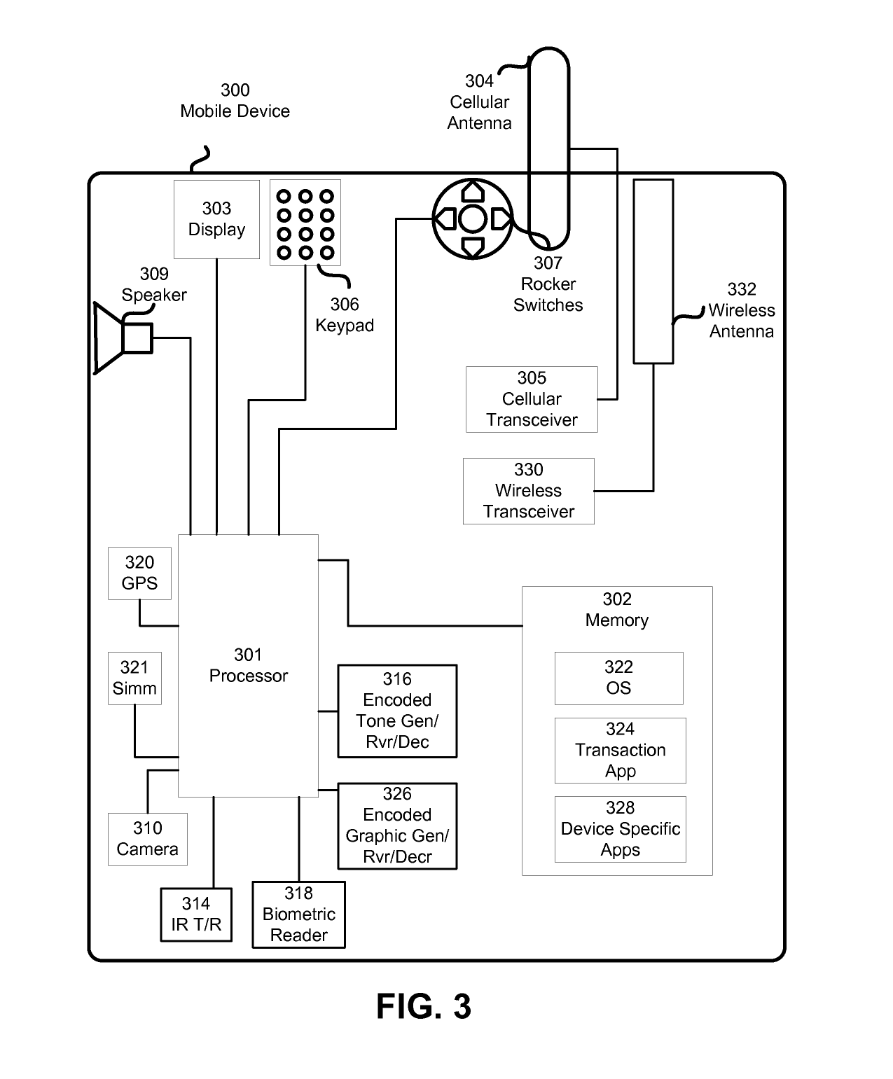

As used herein, the term “mobile device” encompasses any transportable device that is configured to interact with a wireless network. By way of illustration and not by way of limitation, a mobile device may be a smartphone, a tablet, and a laptop computer. One implementation of a mobile device suitable to practice some or all of the embodiments herein is illustrated in FIG. 3.

As used herein, the term “service provider” means an entity that provides services to subscribers for a fee. The services provided by the service provider may be unrelated to the purchases being made by the purchaser. By way of illustration and not by way of limitation, a service provider may provide video, data and voice services over wired and wireless media, utilities companies and all manner of other service providers who are not involved in typical credit card transactions.

As used herein, the term “purchaser” encompasses a person or an entity that procures goods and services and makes payment to a merchant for those goods and services using a mobile device. A purchaser is also a subscriber of services provided by a service provider, which services may be unrelated to the purchase being made.

As used herein, the term “merchant” encompasses an entity that accepts payment from a purchaser using a mobile device for a product or service. As used herein, the term “service provider” encompasses an entity that pays a merchant for goods and services purchased by the purchaser. As used herein a “purchase” encompasses either arranging for delivery of services or obtaining specific goods. In the various embodiments, the service provider provides services that are unrelated to the transaction in which the purchaser is involved, except to make payment to the merchant involved.

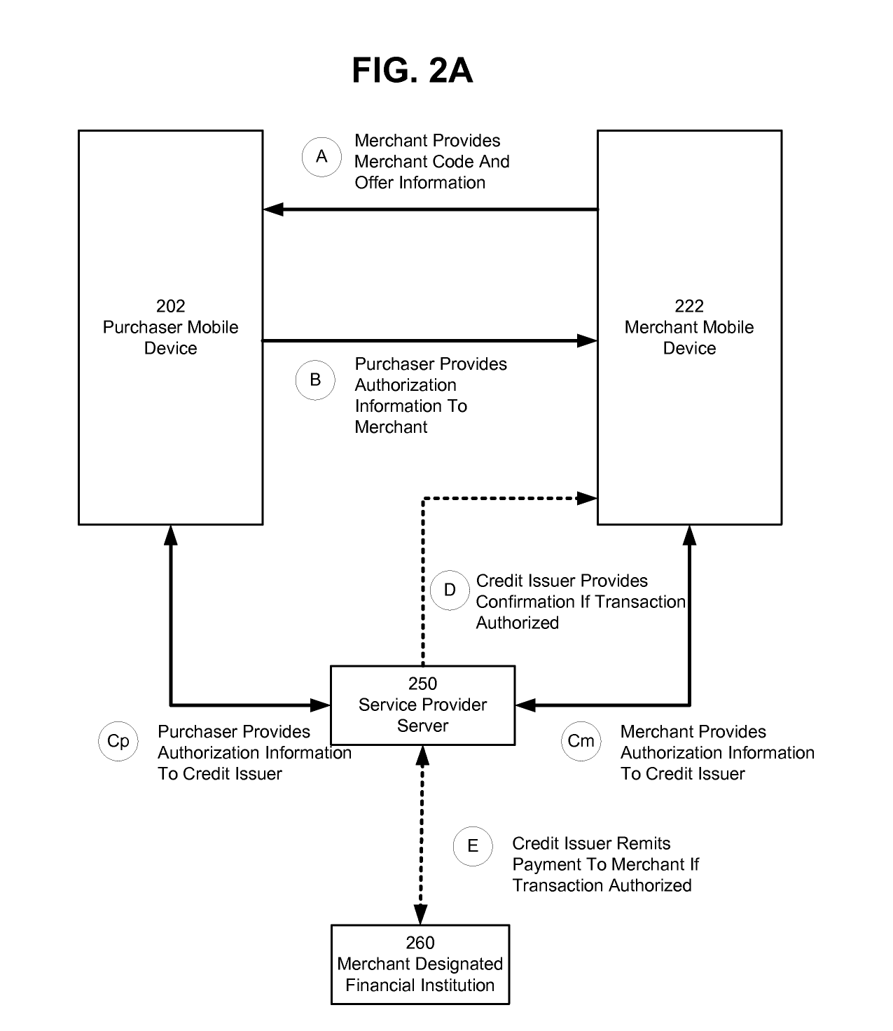

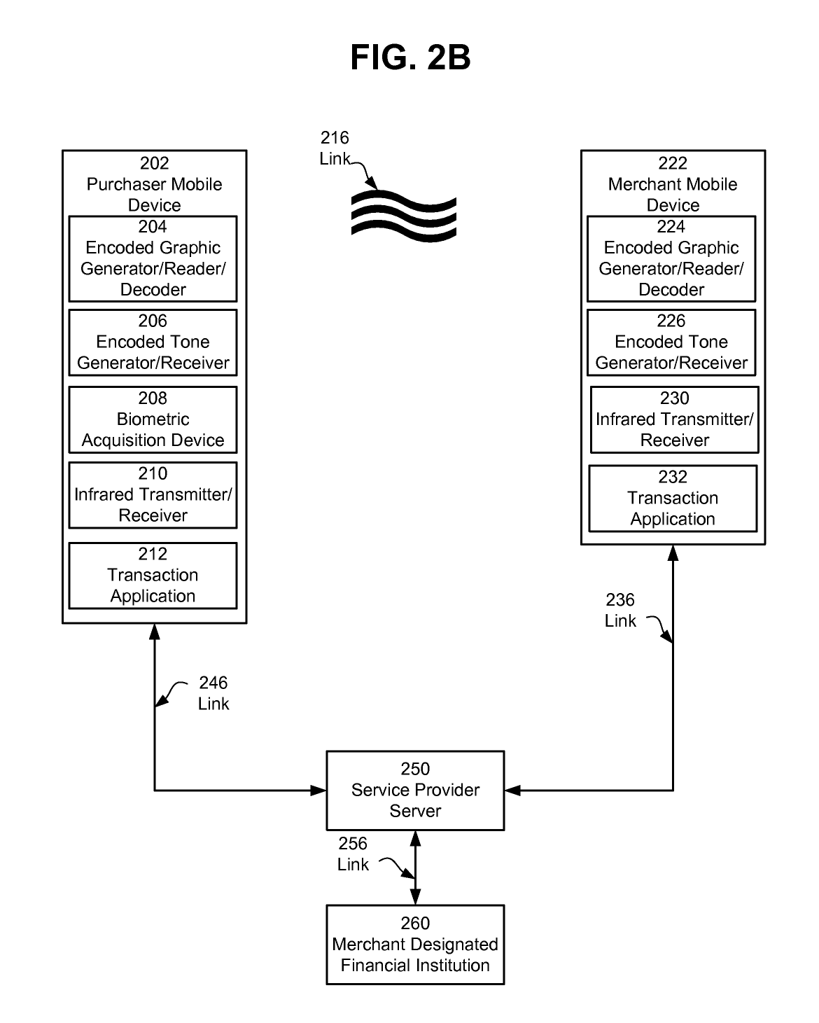

FIG. 2A block diagram illustrating a general flow of a transaction according to an embodiment. While various operations have been identified with sequential letters, the communication represented by a particular letter may not occur sequentially. For example, in an embodiment, a communication between the purchaser mobile device 202 and the service provider server 250 identified by Circle Cp and Cm may occur before a communication identified by Circle B between the purchaser mobile device 202 and the merchant mobile device 222.

A purchaser mobile device 202 and a merchant mobile device 222 are configured with software instructions that cause the purchaser mobile device and the merchant mobile device to exchange sufficient information with each other to consummate an electronic transaction. A merchant mobile device 222 provides information regarding a product or service, including a price, and a merchant identifier to a purchaser mobile device 202. (Circle A). A purchaser who desires to purchase the product or service uses the purchaser mobile device 202 to provide the merchant mobile device 222 with authorization information. (Circle B). The exchange of information between the purchaser mobile device 202 and the merchant mobile device 222 may be accomplished in various ways in embodiments illustrated below.

The purchaser mobile device 202 and the merchant mobile device 222 convey authorization information to a service provider server 250. (Circles Cp and Cm). In an embodiment, the service provider server 250 is operated by or for a service provider. In this embodiment, the operator of the purchaser mobile device is a subscriber of services provided by the service provider. The subscriber has an account with the service provider through which the subscriber is billed for services provided by the service provider. These services may be unrelated to the goods or services being purchased by the purchaser during any transaction.

If the transaction is authorized by the service provider server 250, the service provider server 250 provides a confirmation of the transaction to the merchant. (Circle D). The service provider server 250 pays the merchant by transferring funds to a merchant designated financial institution 260. (Circle E.)

The information exchange between the various devices (the purchaser mobile device 202, the merchant mobile device 222 and the service provider server 250) may be facilitated in various ways.

FIG. 2B is a block diagram illustrating elements of a purchaser mobile device and a merchant mobile device useful in conducting a transaction according to an embodiment.

A purchaser mobile device 202 and a merchant mobile device 222 are configured to exchange sufficient information with each other to consummate an electronic transaction.

The purchaser mobile device 202 may include one or more of the elements illustrated in FIG. 2B. For example, the purchaser mobile device 202 may include an encoded graphic generator/reader/decoder 204, an encoded tone generator/receiver 206, a biometric acquisition device 208, an infrared transmitter/receiver 210 and a transaction application 212.

In an embodiment, the transaction application 212 is configured with software instructions to generate unique purchaser identification information comprising in part a PIN selected by, or assigned to, the user of the device. The purchaser mobile device 202 is also registered with a service provider server 250 with a unique identifier. For example, the unique identifier may be the MAC address of the purchaser mobile device 202 or the SIMM identifier associated with a SIMM card installed in the purchaser mobile device 202. In order to confirm a transaction, both the PIN and the unique device identifier must be provided to the service provider server 250. Multiple mobile devices may be registered to members of a family and associated with a single subscriber account. In an embodiment, each family member is identified on a monthly invoice by name.

In an embodiment, when the transaction software 212 receives the PIN, the transactions software 212 generates a one-time password which in an embodiment may be an authorization code, which is provided to the merchant.

The merchant mobile device 222 may include one or more of the elements illustrated in FIG. 2B. For example, the merchant mobile device 222 may include an encoded graphic generator/reader/decoder 224, an encoded tone generator/receiver 226, an infrared transmitter/receiver 230 and a transaction application 232.

The purchaser mobile device 202 and the merchant mobile device 222 may be connected via a link 216. By way of illustration and not by way of limitation, the link 216 may be established using electromagnetic-based transmissions, light-based transmissions or audio-based transmissions. The link 216 is maintained for the time it takes to complete a transaction between the purchaser mobile device 202 and the merchant mobile device 222. The link 216 facilitates the operations represented by Circles A and B as illustrated in FIG. 2A. As described with respect to FIG. 2A, a merchant mobile device 222 provides information regarding a product or service, including a price, and a merchant identifier to a purchaser mobile device 202. (Circle A).

In an embodiment, a merchant is assigned a merchant identifier. The merchant identifier may be, for example, posted at a check-out kiosk, included in an advertisement, broadcast with programming content on a cable network, or posted on a web site. The merchant identifier may be used to complete a transaction. For example, a purchaser may send an SMS text message from a mobile device to the merchant identifier that authorizes an amount to be paid.

For example, the purchaser may receive a message in the form “Text 99.95 to 55678 to purchase this now.” If the purchaser wishes to confirm the sale, the purchaser would send the message. The receiver ID 55678 could be the service provider server 250 or in an alternative embodiment, if a number of service providers elect to have a common server for processing such financial transactions, the receiver ID could be associated with a common service provider server; and a matching record could also be sent to the specific service provider server associated with the particular purchaser account, for later reconciliation or tracking.

In another embodiment, the merchant identifier is incorporated into an encoded graphic generated by the encoded graphic generator/reader/decoder 224. In an embodiment, the encoded graphic may be a 2D code or an animated 2D code. In another embodiment, the merchant identifier is incorporated into encoded tone generated by the encoded tone generator/receiver 226. In still another embodiment, the encoded tone may be a supersonic tone. In another embodiment, the merchant identifier is encoded in an infrared signal by the infrared transmitter/receiver 230.

The encoded graphic, the encoded tone or the encoded infrared signal may convey additional information (FIG. 2A, Circle A) to the purchaser mobile device 202. By way of illustration and not by way of limitation, the encoded graphic, the encoded tone or the encoded infrared signal may convey an item description and a price of the item.

A purchaser mobile device 202 equipped with an encoded graphic generator/reader/decoder 204 may receive the encoded graphic. A purchaser mobile device 202 equipped with an encoded tone generator/receiver 206 may receive the encoded tone. A purchaser mobile device 202 equipped with an infrared transmitter/receiver 210 may receive the encoded infrared signal.

In an embodiment, the transaction is conducted using an encoded graphic, an encoded tone, an encoded infrared signal or a combination of an encoded graphic, encoded tone or encoded infrared signal.

A transaction application 212 operating on the purchaser mobile device 202 may interpret the encoded graphic, the encoded audio tone or the encoded infrared signal to obtain the merchant ID. The transaction application 212 may operate to display the offer, price and the purchase instructions on a display device (see, FIG. 3, 303). For example, the display may include an instruction to the purchaser to enter a PIN in order to complete the transaction.

As previously described, when the transaction software 212 receives the PIN, the transaction application 212 may generate a one-time password, which may be used as a purchaser authorization code. The authorization code operates as a request by the purchaser to authorize a transaction. The authorization code may be delivered to the service provider server 250 by the purchaser mobile device 202 or by the merchant mobile device 222. In an embodiment, the authentication of the purchaser is further enhanced by the use of a bio-identifier, such as a fingerprint or a retinal scan. The mobile device may include the appropriate hardware and software (Block 208) to receive and confirm that a received bio-identifier matches the bio-identifier on file.

In yet another authentication mechanism in an alternative embodiment, the GPS coordinates of the purchaser, as determined by the purchaser's device (iPad, Smartphone etc.) could be part of an authentication hash. In another embodiment, the purchase would only be permitted if the user was physically in the store (according to GPS coordinates or location based on cell tower proximity). This would reduce fraud, since transactions received from places where the phone was known not to be would be blocked.

In an embodiment, an encoded graphic may be generated by the encoded graphic generator/reader/decoder 204 in response to the entering of a transaction amount by the merchant in a transaction application 232. The encoded graphic may be used to convey an authorization code from the purchaser mobile device 202 to the merchant mobile device 222. The encoded graphic may be read by the encoded graphic generator/reader/decoder 224. Similarly, an encoded tone may be generated by the encoded tone generator/receiver 206 on the purchaser mobile device 202 and read by the encoded tone generator/receiver 226 on the merchant mobile device 222. In yet another embodiment, an infrared signal may be generated on the infrared transmitter/receiver 210 on the purchaser mobile device 202 and read by the infrared transmitter/receiver 230 on the merchant mobile device 222.

In this embodiment, the authorization code is sent to the service provider server 250 by the merchant mobile device 222 via link 236. The service provider server 250 determines whether the transaction is authorized according to rules established by the service provider server. When the transaction is authorized, the service provider server sends a confirmation to the merchant mobile device 222 via the link 236.

In another embodiment, transaction information, which information may include the merchant ID, the price, and the authorization code, is sent by the purchaser mobile device 202 via a link 246 to the service provider server 250. In this embodiment, the service provider server 250 responds by sending a unique code to the merchant mobile device 222.

In another embodiment, when the transaction software 212 operating on the purchaser mobile device 202 receives the PIN, the transaction application 212 may generate a one-time password. The amount to be paid, the current time, and the one-time password are used to generate a one-time public/private key pair. The public key is provided by the purchaser mobile device 202 to the merchant mobile device 222. The public key may be conveyed in the form of an alphanumeric code or it may be presented in the form of an encoded graphic as previously described or by any of the methods previously described (i.e. SMS, Ultrasonic, Infrared etc.). The purchaser mobile device 202 conveys the private key to the service provider server 250 operated by or for the service provider. The private key resides on the service provider server 250 for a fixed period of time, for example 30 seconds. The merchant mobile device sends the public key to service provider server 250 via link 236. The service provider server 250 determines whether the received public key and the received private key match. If the keys match, the service provider server 250 returns an authorization code to the merchant mobile device 222 via link 236. The private key record is then removed (it can only be used once). If a public key that matches the private key is not received by the service provider server 250 within the fixed period of time, the private key is deleted and a failure message is sent to the purchaser mobile device via link 246. The failure message may, for example, provide a reason for the failure, such as “Merchant did not authorize in time.”

In another embodiment, the service provider server generates a one-time “credit card” like number and returns that number to the purchaser. The purchaser's mobile device, if outfitted with a magnetic stripe or an RFID transmitter, may then be used by the merchant as if it were a normal credit card.

In an embodiment, the transaction application 212 operating on the purchaser mobile device 202 tracks purchases. For example, the application may track purchases made with the purchaser mobile device 202, or the application may retrieve information from the service provider server. In an embodiment, the service provider may be the provider of services for the mobile device. In this embodiment, the transaction application 212 may also retrieve other billing-related information, such as number of minutes used (on this mobile device or on another mobile device on the account). In yet another embodiment, the service provider may be another service provider, such as a cable or Internet service provider. The application may retrieve information related to the services provided by the service provider.

Multiple mobile devices may be authorized on a single subscriber account. For instance, multiple family members could have separate mobile devices, each of which is authorized for a different amount of credit (or the same total credit). In an embodiment, each family member is identified on a monthly invoice by name.

Cash register functions, like a merchant code or 2D bar code, etc., may be embedded in offline devices where the value of individual transactions is small enough that a missed or fraudulent transaction can be tolerated. For example, a merchant code may be associated with subway and bus turnstiles, parking meters, and vending machines.

In yet another embodiment, a merchant sale kiosk may include a cradle or cable that facilitates the downloading of a transaction application 212 on a purchaser mobile device 202 and the registration of the purchaser mobile device 202 with a service provider.

A mobile device suitable for use with the various embodiments is illustrated in FIG. 3.

A mobile device 300 may include a processor 301 coupled to an internal memory 302, to a display 303 and to a SIMM 321 or similar removable memory unit. Additionally, the mobile device 300 may optionally have a cellular antenna 304 for sending and receiving electromagnetic radiation that is connected to a cellular transceiver 305 coupled to the processor 301. In some implementations, the transceiver 305 and portions of the processor 301 and memory 302 may be used for multi-network communications. The mobile device 300 may also include a keypad 306 or miniature keyboard and menu selection buttons or rocker switches 307 for receiving user inputs. The mobile device 300 may also include a GPS navigation device 320 coupled to the processor and used to determine the location coordinates of the mobile device 300. Additionally, the display 303 may be a touch-sensitive device that may be configured to receive user inputs.

The mobile device 300 may also include a camera 310, an infrared transmitter receiver 314, an encoded tone generator/receiver/decoder 316, a biometric reader 318, and an encoded graphic generator/receiver/decoder 326. These elements may be used to perform various functions assigned to the purchaser mobile device 202 and the merchant mobile device 222 as described above.

A wireless transceiver 330 may provide wireless communications via a wireless antenna 332. By way of illustration and not by way of limitation, the wireless transceiver 330 may be compliant with 802.11x standards.

The processor 301 may be any programmable microprocessor, microcomputer or multiple processor chip or chips that can be configured by software instructions (applications) to perform a variety of functions, including the functions of the various embodiments described herein. In an embodiment, the mobile device 300 may include multiple processors 301, such as one processor dedicated to cellular and/or wireless communication functions and one processor dedicated to running other applications.

Typically, software applications may be stored in the internal memory 302 before they are accessed and loaded into the processor 301. For example, the internal memory 302 may include transaction application 324 and device-specific application 328. Applications 324 and 328 may be used to perform various functions assigned to purchaser mobile device 202 and merchant mobile device 222 as described above. In an embodiment, the processor 301 may include or have access to an internal memory 302 sufficient to store the application software instructions. The memory may also include an operating system 322.

The internal memory of the processor may include a secure memory (not illustrated) which is not directly accessible by users or applications and that is capable of recording MDINs and SIMM IDs as described in the various embodiments. As part of the processor, such a secure memory may not be replaced or accessed without damaging or replacing the processor.

Additionally, the internal memory 302 may be a volatile or nonvolatile memory, such as flash memory, or a mixture of both. For the purposes of this description, a general reference to memory refers to all memory accessible by the processor 301, including internal memory 302, removable memory plugged into the computing device, and memory within the processor 301 itself, including the secure memory.

In an embodiment, additional memory chips (e.g., a Secure Data (SD) card) may be plugged into the mobile device 300 and coupled to the processor 301.

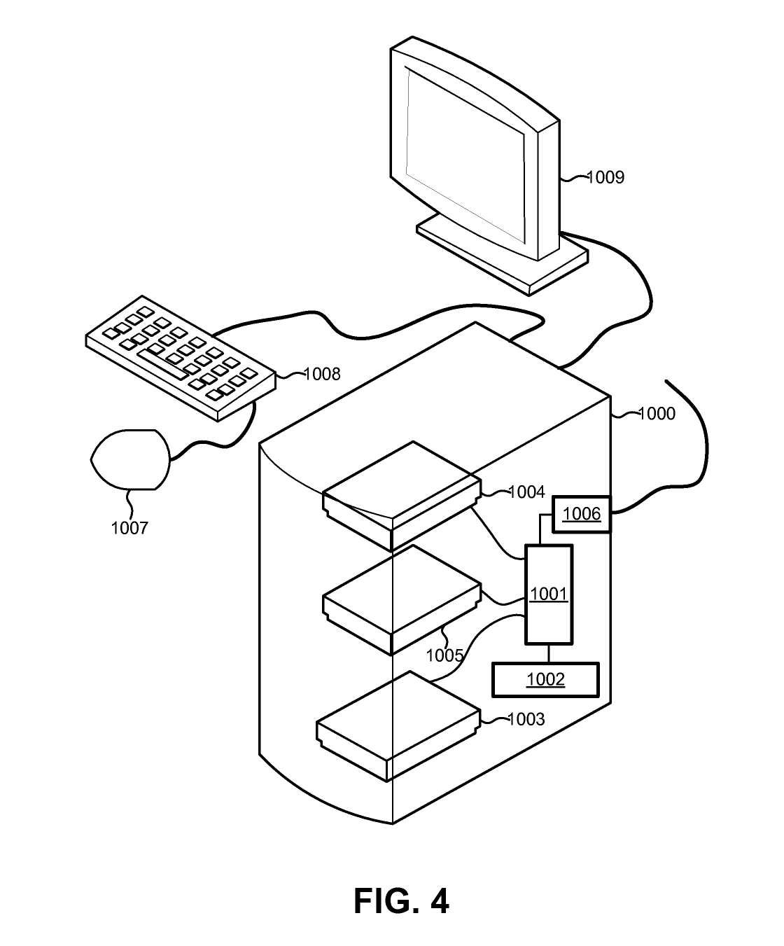

FIG. 4 is a block diagram of a computing device suitable for use with any of the embodiments. Such a computing device 1000 typically includes a processor 1001 coupled to volatile memory 1002 and a large capacity nonvolatile memory, such as a disk drive 1003. Typically, software applications may be stored in the internal memory 1002 before they are accessed and loaded into the processor 1001. The processor 1001 may include internal memory sufficient to store the application software instructions.

The computing device 1000 may also include a floppy disc drive 1004 and a compact disc (CD) drive 1005 coupled to the processor 1001. Typically the computing device 1000 will also include a pointing device such as a mouse 1007, a user input device such as a keyboard 1008 and a display 1009. The computing device 1000 may also include a number of connector ports 1006 coupled to the processor 1001 for establishing data connections or network connections or for receiving external memory devices, such as a USB or FireWire® connector sockets. In a notebook configuration, the computer housing includes the pointing device 1007, keyboard 1008 and the display 1009 as is well known in the computer arts.

While the computing device 1000 is illustrated as using a desktop form factor, the illustrated form is not meant to be limiting. For example, some or all of the components of computing device 1000 may be implemented as a desktop computer, a laptop computer, a mini-computer, or a personal data assistant.

The computing device 1000 may also be configured with hardware and software (not illustrated) to perform operations assigned to the purchaser mobile device 202 and the merchant mobile device 222.

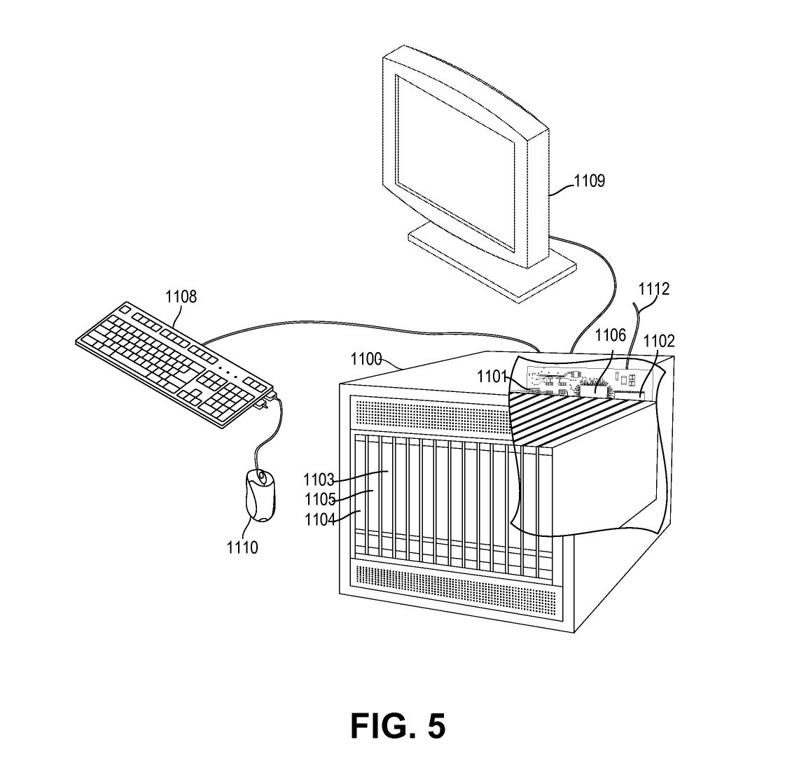

The various embodiments may also be implemented on any of a variety of commercially available server devices, such as the server 1100 illustrated in FIG. 5. The server device 1100 may also be configured with hardware and software (not illustrated) to perform operations assigned to the service provider server 250. Such a server 1100 typically includes a processor 1101 coupled to volatile memory 1102 and a large capacity nonvolatile memory, such as a disk drive 1103. The server 1100 may also include a floppy disc drive, compact disc (CD) or DVD disc drive 1104 coupled to the processor 1101. The server 1100 may also include network access ports 1106 coupled to the processor 1101 for establishing data connections with a network 1112, such as a local area network coupled to other broadcast system computers and servers. Servers 1100 may also include operator interfaces, such as a keyboard 1108, pointer device (e.g., a computer mouse 1110), and a display 1109.

The processors 1001, 1101 may be any programmable microprocessor, microcomputer or multiple processor chip or chips that can be configured by software instructions (applications) to perform a variety of functions, including the functions of the various embodiments described below. In some mobile receiver devices, multiple processors may be provided, such as one processor dedicated to wireless communication functions and one processor dedicated to running other applications. Typically, software applications may be stored in the internal memory 1002, 1102, 1103 before they are accessed and loaded into the processor 1001, 1101. The processor 1001, 1101 may include internal memory sufficient to store the application software instructions.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. Non-transitory computer-readable or processor-readable media include both computer storage media and tangible storage media that facilitate transfer of a computer program from one place to another. Non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor- readable medium and/or computer-readable medium, which may be incorporated into a computer program product.

When implemented in hardware, the functionality may be implemented within circuitry of a wireless signal processing circuit that may be suitable for use in a wireless receiver or mobile device. Such a wireless signal processing circuit may include circuits for accomplishing the signal measuring and calculating steps described in the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

Any reference to claim elements in the singular, for example, using the articles “a,” “an” or “the,” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

1. An electronic payment system using a mobile device for purchases and billing to a service provider account of a subscriber, the system comprising:
a purchaser mobile device;
a merchant mobile device; and
a service provider server, wherein
the purchaser mobile device is configured with software instructions that when executed cause the purchaser mobile device to perform operations comprising:
obtaining from the merchant mobile device purchase information to complete a purchase, wherein the purchase information comprises an amount to be paid;
generating a one-time password from a personal identification number (PIN);
generating a one-time public/private key pair from the amount to be paid, a current time, and the one-time password;
communicating the public key to the merchant mobile device; and
communicating the private key to the service provider server;
the merchant mobile device is configured with software instructions that when executed cause the purchaser mobile device to perform operations comprising:
receiving the public key from the purchaser mobile device; and
communicating the public key to the service provider server and
the service provider server is configured with software instructions that when executed cause the service provider server to perform operations comprising:
receiving the public key from the merchant mobile device and the private key from the purchaser mobile device;
determining whether the public key and the private key form a public/private key pair;
returning an authorization to the merchant mobile device when the public key and the private key form a public/private key pair; and
billing the service provider account associated with the subscriber the purchase price when the public key and the private key form a public/private key pair.

2. The system of claim 1, wherein the purchaser mobile device further comprises a graphic code reader and wherein the operation by the purchaser mobile device of obtaining purchase information comprises obtaining information from an encoded graphic associated with the purchase using the graphic code reader.

3. The system of claim 1, wherein the purchaser mobile device further comprises a tone receiver and wherein the operation by the purchaser mobile device of obtaining the purchase information comprises obtaining the purchase information using the tone receiver from an encoded tone associated with the purchase.

4. The system of claim 1, wherein the purchaser mobile device further comprises an infrared (IR) receiver and wherein the operation by the purchaser mobile device of obtaining the purchase information comprises obtaining the purchase information using the IR receiver information from an IR signal associated with the purchase.

5. The system of claim 1, wherein the service provider server is configured with software instructions that when executed cause the service provider server to further perform operations comprising deleting the public key and the private key when the public key and the private key form the public/private key pair.

6. The system of claim 1, wherein the service provider server is configured with software instructions that when executed cause the service provider server to further perform operations comprising;
deleting the public key and the private key when the public key that together with the private key form the public/private key pair is not received with a preset time; and
sending a transaction failure message to the merchant mobile device when the public key that together with the private key form the public/private key pair is not received with a preset time.

7. (canceled)

8. The system of claim 1, wherein the operation by the purchaser mobile device of communicating the public key to the merchant mobile device comprises the purchaser mobile device and the merchant mobile device communicating using signals selected from the group consisting of IR signals, tone signals, and radio frequency signals.

9. The system of claim 1, wherein the purchaser mobile device comprises a graphic code generator and display and the operation by the purchaser mobile device of communicating the public key to the merchant mobile device comprises:
generating by the purchaser mobile device a graphic code representing the public key and
displaying by the purchaser mobile device the graphic code on the display; and
wherein the merchant mobile device comprises a graphic code reader and the operation by the merchant device of receiving the public key from the purchaser mobile device comprises:
reading by the merchant mobile device the graphic code displayed by the purchaser mobile device; and
acquiring from the graphic code the public key.

10-12. (canceled)

13. The system of claim 1 wherein the service provider server comprises separate files associated with multiple service providers, the service provider server configured with software instructions that cause the service provider server to perform operations in support of each individual service provider.

14. A method for using a mobile device for purchases and billing to a subscriber account, the method comprising:
obtaining by a purchaser mobile device from the merchant mobile device purchase information to complete a purchase, wherein the purchase information comprises an amount to be paid;
generating a one-time password from a personal identification number (PIN);
generating a one-time public/private key pair from the amount to be paid, a current time, and the one-time password;
communicating by the purchaser mobile device the public key to a merchant mobile device;
communicating by the purchaser mobile device the private key to a service provider server;
receiving by the merchant mobile device the public key from the purchaser mobile device; and
communicating by the merchant mobile device the public key to the service provider server;
receiving by the service provider server the public key from the merchant mobile device and the private key from the purchaser mobile device;
determining by the service provider server whether the public key and the private key form a public/private key pair;
returning by the service provider server an authorization to the merchant mobile device when the public key and the private key form a public/private key pair; and
billing by the service provider server the service provider account associated with the subscriber the purchase price when the public key and the private key form a public/private key pair.

15. The method of claim 14, wherein the purchaser mobile device further comprises a graphic code reader and wherein obtaining purchase information comprises obtaining, using the graphic code reader, information from an encoded graphic associated with the purchase.

16. The method of claim 14, wherein the purchaser mobile device further comprises a tone receiver and wherein obtaining the purchase information comprises obtaining, using the encoded tone receiver, the purchase information from an encoded tone associated with the purchase.

17. The method of claim 14, wherein the purchaser mobile device further comprises an infrared (IR) receiver and wherein obtaining the purchase information comprises obtaining, using the IR receiver, the purchase information from an IR signal associated with the purchase.

18. The method of claim 14 further comprising deleting by the service provider server the public key and the private key when the public key and the private key form the public/private key pair.

19. The method of claim 18 further comprising:
deleting by the service provider server the public key and the private key when the public key that together with the private key form the public/private key pair is not received with a preset time; and
sending by the service provider server a transaction failure message to the merchant mobile device when the public key that together with the private key form the public/private key pair is not received with a preset time.

20. (canceled)

21. The method of claim 14, wherein communicating the purchase information and the unique purchaser information public key to a merchant mobile device comprises the purchaser mobile device and the merchant mobile device communicating using signals selected from the group consisting of IR signals, tone signals, and radio frequency signals.

22. The method of claim 14, wherein the purchaser mobile device comprises a graphic code generator and display, and communicating by the mobile device the public key to a merchant mobile device comprises:
generating by the purchaser mobile device a graphic code representing the public key; and
displaying by the purchaser mobile device the graphic code on the display; and
wherein the merchant mobile device comprises a graphic code reader, and receiving by the merchant mobile device the public key from the purchaser mobile device comprises:
reading by the merchant mobile device the graphic code displayed by the purchaser mobile device; and
acquiring from the graphic code the public key.

23-25. (canceled)

26. The method of claim 14 wherein the service provider server comprises separate files associated with multiple service providers, the service provider server configured with software instructions that cause the service provider server to perform operations in support of each individual service provider.
